(19) United States
(12) Patent Application Publication
(10) Pub. No.: US 2005/0013616 A1
(43) Pub. Date: Jan. 20, 2005

(54) Optical antenna system for free-space optical communication system

(76) Inventor: Kelson Yen, Taichung (TW)

Correspondence Address: DELLETT AND WALTERS, P. O. BOX 2786, PORTLAND, OR, 97208-2786, US

(21) Appl. No.: 10/619,107

(22) Filed: Jul. 14, 2003

(51) Int. Cl. H04B 10/00

(52) U.S. Cl. 398/130

(57) ABSTRACT

An optical antenna system for a free-space communication system includes a fixed and an adjustable optical antenna assemblies. The fixed optical antenna assembly includes a dual wavelength optical transmitter assembly and a single wavelength receiver assembly. The dual wavelength optical transmitter assembly includes a convex lens with a focal point and a dual wavelength optical transmitter mounted at the focal point to produce a first and a second laser beam with different wavelengths. The adjustable optical antenna assembly includes a dual wavelength optical receiver assembly and a single wavelength transmitter assembly. The dual wavelength optical receiver assembly uses an optical splitter to direct the two laser beams respectively through two optical filters to an optical alignment detector and an optical data detector. Thereby saving cost, size and weight of the optical antenna system.

### BACKGROUND OF THE INVENTION

1. Field of the Invention

The present invention relates to an optical antenna system for a free-space optical communication system, and more particularly to an optical antenna system that has a dual laser transmission unit to perform the tasks of alignment and data transmission simultaneously for a free-space optical communication system.

2. Description of Related Art

The marriage of the Internet and wireless communications technology has caused wireless communications technology to be the fastest growing technology in recent years. The Internet consists of lots of networks including local area networks (LAN) that communicate with each other. Typically, optical fiber, coaxial cables or wire cables are the media used to connect two networks together. However, installing the optical fiber, coaxial cables or wire cable is generally time consuming and expensive.

Wireless communication technology can be installed more conveniently than conventional media. Free-space optical (FSO) technology provides a wireless communication environment with data and information transfer speed equivalent to optical fiber. With reference to FIGS. 4 and 5, free-space optical technology can be used to link local area networks (not numbered) in a building A (60) and a building B (61). Separate local area networks (LAN) or Intranets are installed in building A (60) and the building B (61) to provide a medium to exchanging data or information between workstations (not numbered) in the buildings (60, 61). The free-space optical communication system uses an optical antenna system (not numbered) to establish a communication link between the two buildings (60, 61).

A conventional optical antenna system in accordance with the prior art in a free-space optical communication system comprises a first optical antenna assembly (63) and a second antenna assembly (64) that are mounted respectively on the two buildings (60, 61) and correspond to each other. The first and the second antenna assemblies (63, 64) connect respectively to the networks and communicate with each other by means of laser beams (not shown) that transmit information or data in optical signal form.

With further reference to FIG. 6, the first optical antenna assembly (63) comprises a first optical receiver assembly(631), a first optical transmitter assembly (632) and an optical alignment transmitter assembly (633). The first optical receiver assembly (631) has a first optical detector (635) and a convex lens (65) with a focal point (not shown). The first optical transmitter assembly (632) has a first optical transmitter (636) and a convex lens (65) with a focal point (not shown). The optical alignment transmitter assembly (633) has an optical alignment transmitter (637) and a convex lens (65) with a focal point (not shown). The first optical detector (635), the first optical transmitter (636) and the optical alignment transmitter (637) are mounted respectively at the focal points of the convex lenses (65).

With further reference to FIG. 7, the second optical antenna assembly (64) comprises a second optical transmitter assembly (641), a second optical receiver assembly (642) and an optical alignment receiver assembly (643). The second optical transmitter assembly (641) has a second optical transmitter (645) and a convex lens (65) with a focal point (not shown). The second optical receiver assembly (642) has a second optical detector (646) and a convex lens (65) with a focal point (not shown). The optical alignment receiver assembly (643) has an optical alignment detector (647) and a convex lens (65) with a focal point (not shown). The second optical transmitter (645), the second optical detector (646) and the optical alignment detector (647) are mounted respectively at the focal points of the convex lenses (65).

Since the free-space optical communication system uses laser beams for data and information exchange, the first and the second optical antenna assemblies (63, 64) must be aligned with each other during the data and information exchange. Therefore, the optical alignment transmitter (637) in the first optical antenna assembly (63) emits a laser beam (not shown) through the corresponding convex lenses (65) to the optical alignment detector (647) in the second optical antenna assembly (64), and the second optical antenna assembly (64) aligns with the signal received from the first optical antenna assembly (63). Thereafter, the laser beam emitted by the first optical transmitter (636) will be efficiently received by the second optical detector (646). Likewise, the laser beam emitted by the second optical transmitter (645) will be efficiently received by the first optical detector (635). Consequently, a duplex data communication link for the free-space communication system is established.

However, current optical antenna assemblies (63, 64) with a self-alignment capability typically have at least three sets of optics. For example, the first optical antenna assembly (60) contains a unique set of optics in a first optical transmitter assembly (631), a first optical receiver assembly (632) and an optical alignment transmitter assembly (633). So many elements in an optical antenna assembly will cause the optical antenna assembly to be bulky and heavy. Besides, fabrication cost of the optical antenna assembly will be generally high.

The optical alignment transmitter assembly (633) must be precisely parallel with the other optical assemblies (631, 632) in the first optical antenna assembly (63). Therefore, precise installation of the optical alignment transmitter assembly (633) and the other optical assemblies (631, 632) in the first optical antenna assembly (63) is not easy. Precise parallel alignment of the optical alignment transmitter assembly (633) and the other optical assemblies (631, 632) requires a lot of time.

To overcome the shortcomings, the present invention provides an optical antenna system for a free-space optical communication system to mitigate or obviate the aforementioned problems.

### SUMMARY OF THE INVENTION

The main objective of the present invention is to provide an optical antenna system for a free-space optical communication system, which will solve the problem of parallel alignment of internal optical assemblies.

Another objective of the present invention is to provide an optical antenna system with fewer elements thereby reducing cost, weight and size of the optical antenna system.

Other objectives, advantages and novel features of the invention will become more apparent from the following detailed description when taken in conjunction with the accompanying drawings.

### BRIEF DESCRIPTION OF THE DRAWINGS

FIG. 1 is a schematic of an optical antenna system in accordance with the present invention for a free-space communication system;

FIG. 2 is a block diagram of a fixed optical antenna assembly in the optical antenna system in FIG. 1;

FIG. 3 is a block diagram of an adjustable optical antenna assembly in the optical antenna system in FIG. 1;

FIG. 4 is an operational perspective view of a link in a free-space optical communication system;

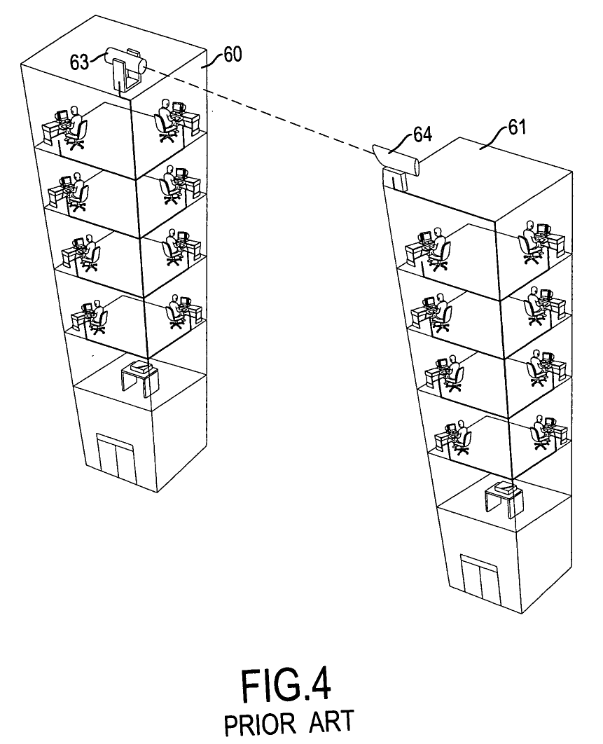

FIG. 5 is a schematic of a conventional optical antenna system in accordance with the prior art for a free-space communication system;

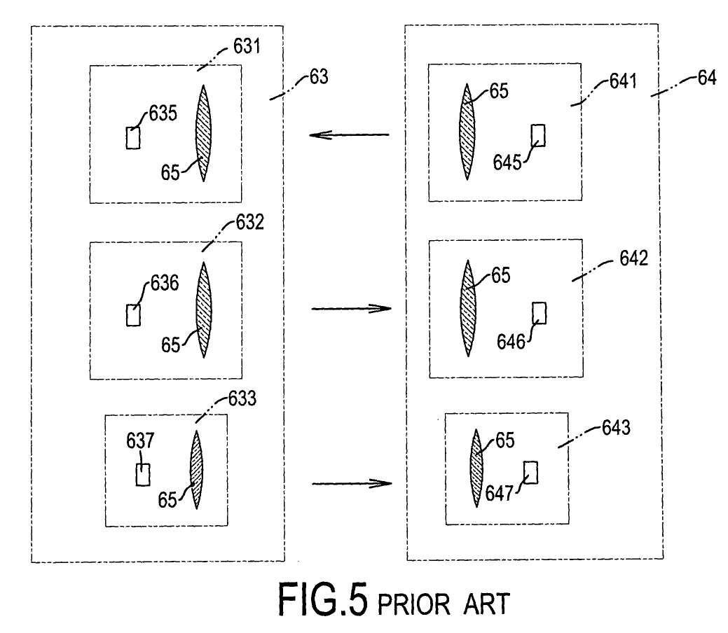

FIG. 6 is a block diagram of a first optical antenna assembly in the optical antenna system in FIG. 5; and

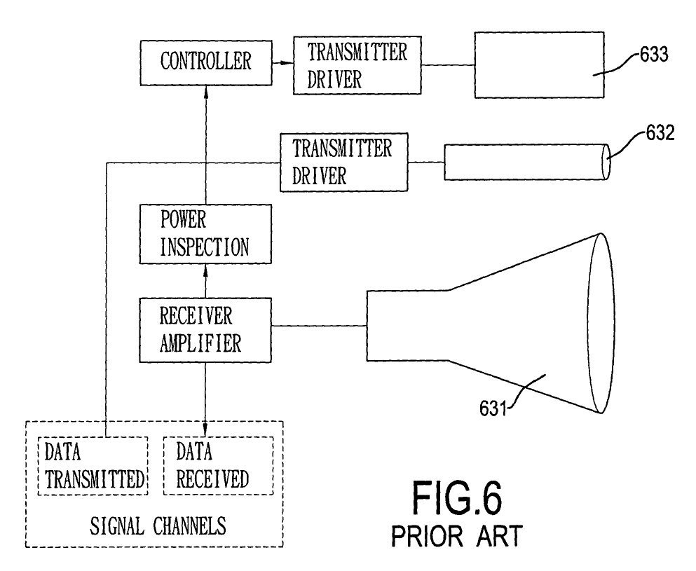

FIG. 7 is a block diagram of a second optical antenna assembly in the optical antenna system in FIG. 5.

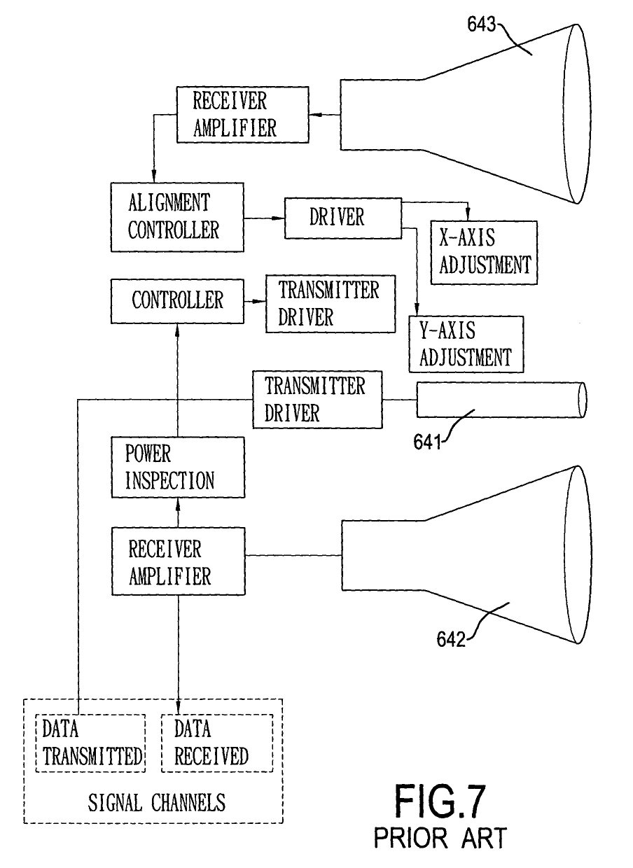

### DETAILED DESCRIPTION OF PREFERRED EMBODIMENT

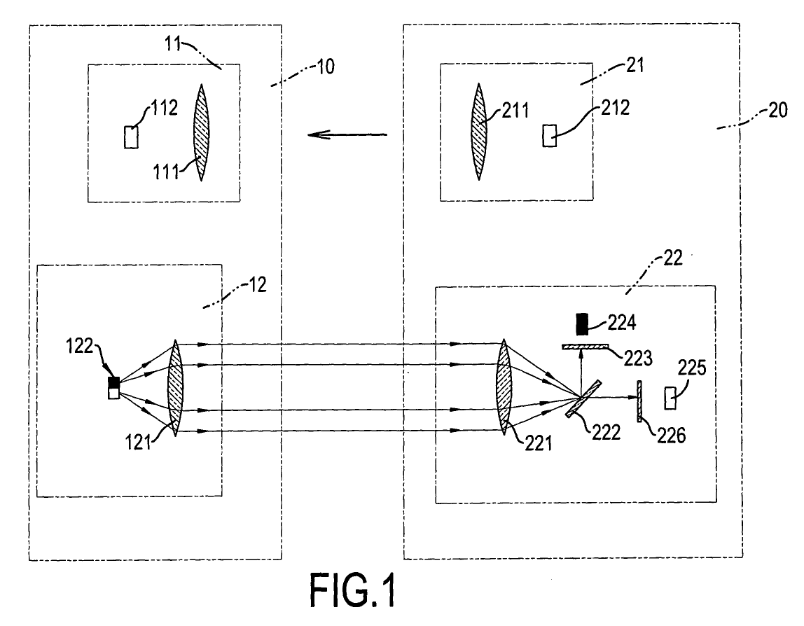

With reference to FIG. 1, an optical antenna system for a free-space communication system in accordance with the present invention comprises a fixed optical antenna assembly (10) and an adjustable optical antenna assembly (20).

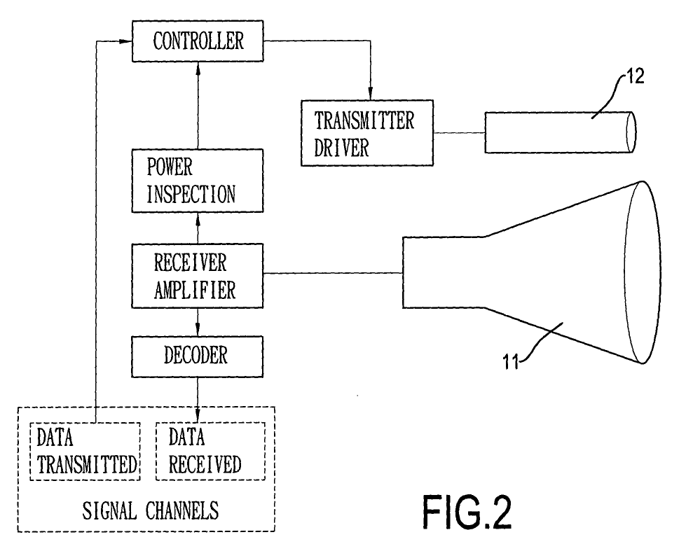

With further reference to FIG. 2, the fixed optical antenna assembly (10) comprises a single wavelength optical receiver assembly (11) and a dual wavelength optical transmitter assembly (12). The single wavelength optical receiver assembly (11) is conventional and comprises a first convex lens (111) and a single wavelength optical detector (112). The first convex lens (111) has a focal point (not shown). The single wavelength optical detector (112) is mounted at the focal point of the first convex lens (111) to detect optical signals (not shown) and send the optical signals to a receiver amplifier (not numbered) in the free-space communication system for further processing.

The dual wavelength optical transmitter assembly (12) comprises a second convex lens (121) and a dual wavelength optical transmitter (122). The second convex lens (121) has a focal point (not shown). The dual wavelength optical transmitter (122) is mounted at the focal point of the second convex lens (121) and is driven by a transmitter driver (not numbered) in the free-space communication system. The dual wavelength optical transmitter (122) simultaneously emits a first laser beam (not numbered) and a second laser beam (not numbered) that have different wavelengths respectively for alignment and data exchange. The first laser beam is used to align the second optical antenna assembly (20) with the single wavelength optical antenna assembly (10). The second laser beam is used to transmit data.

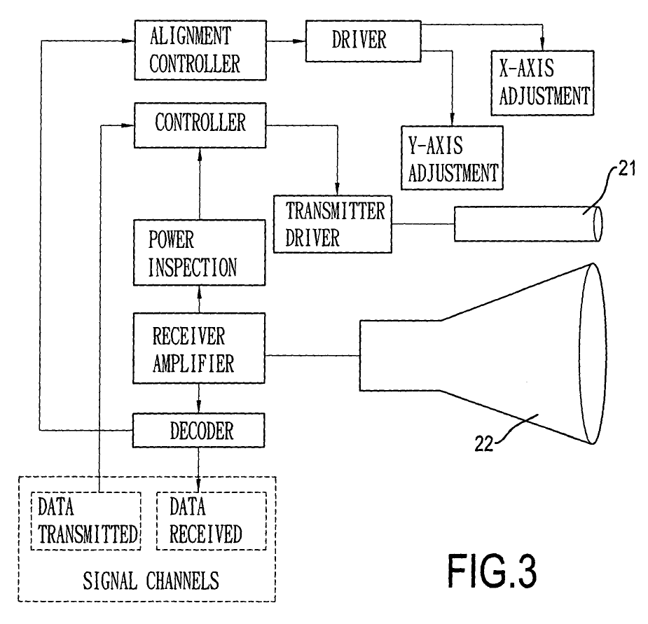

With reference to FIG. 3, the adjustable optical antenna assembly (20) is corresponds to the fixed antenna assembly (10) and comprises a single wavelength optical transmitter assembly (21) and a dual wavelength optical receiver assembly (22). The single wavelength optical transmitter assembly (21) is conventional and corresponds to the single wavelength optical receiver assembly (11) in the fixed optical antenna assembly (10) to establish a one-directional data communication link between the two single wavelength optical assemblies (11, 21).

The optical transmitter assembly (21) comprises a third convex lens (211) and an optical transmitter (212). The third convex lens (211) has a focal point (not shown). The optical transmitter (212) is mounted at the focal point of the third convex lens (211) and is driven by a transmitter driver (not numbered) in the free-space communication system. A laser beam is produced by the optical transmitter (212), passes through the third and the first convex lenses (211, 111) and is received by the optical detector (112) in the single wavelength optical receiver assembly (11) to create a communication link.

The dual wavelength optical receiver assembly (22) corresponds to the dual wavelength optical transmitter assembly (12) and comprises a fourth convex lens (221), an optical splitter (222), an optical alignment filter (223), an optical data filter (226), an optical alignment detector (224) and an optical data detector (225). The fourth convex lens (221) has a focal point (not shown), and the optical splitter (222) is mounted at the focal point of the fourth convex lens (221). The optical splitter (222) reflects the first laser beam and is transparent to the second laser beam.

The optical alignment detector (224) is mounted in a position to receive the reflected first laser beam and passes the received signal to an alignment controller (not numbered) in the free-space communication system. The optical alignment filter (223) is mounted between the optical alignment detector (224) and the optical splitter (222) to filter out any reflected part of the second laser beam.

The optical data detector (225) is mounted in a position to receive the second laser beam transmitted through the optical splitter (222) and pass a received signal to a receiver amplifier (not numbered) in the free-space communication system. The optical data filter (226) is mounted between the optical data detector (225) and the optical splitter (222) and is separated from the optical alignment detector (224) by an angle of 90°.

Since the transmitter assemblies for optical alignment and data exchange in the convention optical antenna system are merged into a single optical assembly, the number of elements in the optical antenna assemblies (10, 20) are reduced. Therefore, the entire optical antenna system has less volume, weight and cost.

Since only two optical assemblies in each optical antenna assembly (10, 20) have to be aligned parallel, assembly of the optical antenna assemblies (10, 20) is easier and more convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical antenna system for a free-space communication system, and the optical antenna system comprising
a fixed optical antenna assembly comprising
a single wavelength optical receiver assembly comprising
a first convex lens with a focal point; and
a single wavelength optical detector mounted at the focal point of the first convex lens; and
a dual wavelength optical transmitter assembly comprising
a second convex lens with a focal point; and
a dual wavelength optical transmitter mounted at the focal point of the second convex lens to produce a first and a second laser beam with different wavelengths; and
an adjustable optical antenna assembly corresponding to the fixed optical antenna assembly and comprising
a single wavelength optical transmitter assembly corresponding to the single wavelength optical receiver assembly in the fixed optical antenna assembly and comprising
a third convex lens with a focal point; and
a single wavelength optical transmitter mounted at the focal point of the third convex lens; and
a dual wavelength optical receiver assembly corresponding to the dual wavelength optical transmitter assembly and comprising
a fourth convex lens having a focal point; and
an optical splitter mounted at the focal point of the fourth convex lens to reflect the first laser beam and being transparent to the second laser beam;
an optical alignment detector mounted in a position corresponding to the optical splitter to receive the reflected first laser beam and to pass a received signal to an alignment controller in the free-space communication system;
an optical alignment filter mounted between the optical alignment detector and the optical splitter;
an optical data detector mounted in a position corresponding to the optical splitter to receive the second laser beam and to pass a received signal to a receiver amplifier in the free-space communication system; and
a second optical filter mounted between the optical data detector and the optical splitter.

2. The optical antenna system for a free-space communication system as claimed in claim 1, wherein the optical data detector is separated from the optical alignment detector by an angle of 90°.
